(19) United States
(12) Patent Application Publication
(10) Pub. No.: US 2004/0228788 A1
(43) Pub. Date: Nov. 18, 2004

(54) Carbon dioxide absorption and fixation method for flue gas

(76) Inventors: Teruo Nagai, Tokyo (JP); Takashi Kuwabara, Tokyo (JP); Yoshihiro Koshiba, Tokyo (JP); Kouji Amano, Tokyo (JP)

Correspondence Address: MOSER, PATTERSON & SHERIDAN, L.L.P., Suite 1500, 3040 Post Oak Blvd., Houston, TX, 77056, US

(21) Appl. No.: 10/785,908

(22) Filed: Feb. 24, 2004

(30) Foreign Application Priority Data
Feb. 26, 2003 (JP) 2003-49377

(51) Int. Cl. C01F 11/18

(52) U.S. Cl. 423/432

(57) ABSTRACT

The present invention provides a low-cost carbon dioxide fixation method that allows effective usage of a large amount of generated coal ashes, and effective fixation of carbon dioxide included in flue gas generated from coal, refuse, or waste product, as well as improvement in the applicability of coal ashes to various applications and effective usage of by-product carbonate. Carbon dioxide is absorbed and fixated by subjecting the flue gas to gas-liquid contact with coal ash water slurry or coal ash eluate so as to make the carbon dioxide in the flue gas react and be absorbed thereinto, thereby fixating the carbon dioxide as carbonate. This method can be favorably used for disposal of flue gas from a boiler at a coal thermal power plant.

### CROSS-REFERENCE TO RELATED APPLICATIONS

This application claims foreign priority benefits under 35 U.S.C. §119 to co-pending Japanese patent application number 200349377, filed Feb. 26, 2003. This related patent application is herein incorporated by reference in its entirety.

### BACKGROUND OF THE INVENTION

1. Field of the Invention

The present invention relates to a method of fixating carbon dioxide included in flue gas, which is emitted from a coal thermal power plant or a garbage incineration plant. More specifically, it relates to a method of fixating carbon dioxide included in coal-fired flue gas.

2. Description of the Related Art

Since there are abundant coal reserves in many places of the Pacific Rim, coal has been evaluated as a superior energy source with supply and cost stability. However, there is a drawback that coal emits a large quantity of CO₂ in contrast to other fossil fuels. In addition, the amount of emission of coal ashes generated from coal combustion has increased year by year, which thus develops into a problem of disposal thereof. The amount of emission of CO₂ in a power generation field is 70 for natural gas, and 80 for oil relative to 100 for coal. That is, coal emits more CO₂ than other fossil foils.

In order to solve those problems, a method of reducing an amount of coal to be used by improving the thermal efficiency, or a method of collecting emitted CO₂ from flue gas can be considered. The former has been developed through the development of coal gasification combined-cycle generation technology that allows generation of electric power by gasifying coal and executing combined-cycle generation. As for the latter, a method of selective CO₂ removal from flue gas through absorption or adsorption has been developed. As a method of CO₂ absorption, a method utilizing physical adsorption to synthetic zeolite has been developed. Meanwhile, as a chemical method, a selective CO₂ absorption method using amine has been developed. Moreover, although it is still in the basic stage, a separation method utilizing a polymer membrane or a cryogenic separation method has been developed.

However, all of these processes must use a method of fixating CO₂ by once absorbing/adsorbing and separating CO₂ from a CO₂ included mixed gas, followed by releasing CO₂ as gas again and isolating. With such conventional methods, CO₂ is fixated after being subjected to a two-stage process of isolation and fixation of CO₂ gas. Therefore, a system is complicated and cost for building facilities is high. With a chemical method, an amine system compound, or with a physical method, synthetic zeolite is used as a material for separating CO₂, thus cost for implementation including those materials is also high. In addition, since energy consumed in the process increases, plant efficiency extremely decreases.

Japanese Patent Application Laid-Open No. Hei 11-192416 discloses carbon dioxide fixation methods such as: a method of fixating carbon dioxide as carbonate by pressurizing carbon dioxide included gas such as coal-fired flue gas so as to reach supercritical pressure and contacting that gas with combustion ash including a metallic oxide such as coal ash, carbonating the carbon dioxide; or a method of fixating as carbonate by decreasing the coal combustion temperature so as to increase the reaction rate of exothermic reaction, making the resulting generated carbon dioxide react with a metallic oxide in combustion ash, thereby carbonating that carbon dioxide (see Patent Material 1.) Nevertheless, there is a problem with the former method in that energy cost increases due to pressurization, and a problem with the latter method in that fixating carbon dioxide in a boiler while combusting allows the resulting fixated carbon dioxide gas to coexist with other components or many impurities.

In Japanese Patent Application Laid-Open No. Sho 59-170310, a method of reclamation with air included coal ash slurry, which is generated by introducing air into the coal ash slurry, in order to control increase in pH accompanied with water slurrying has been disclosed as an effective usage of a large amount of generated coal ashes (see Patent Material 2). However, no other usages have been described.

Japanese Patent Application Laid-Open No. Hei 10-192701 discloses a method for manufacturing a desulfurizing agent by directly reacting the calcium carbonate with the coal ashes, which comprises the steps of converting calcium carbonate with extremely low water-solubility to a form of a calcium ion (Ca²⁺) in hot water under a carbon dioxide gas atmosphere, and then making this calcium ion hydrate with the components of alumina and hydrated silica eluted from the coal ashes hydrate in hot water under the carbon dioxide gas atmosphere (see Patent Material 3.) However, a carbon dioxide fixation method has not been described.

### SUMMARY OF THE INVENTION

The present invention is developed considering the above-mentioned conventional problems, and aims to provide a low-cost carbon dioxide fixation method that allows effective usage of a large amount of generated coal ashes, efficient fixation of carbon dioxide included in flue gas generated when combusting coal, refuse, or waste product, as well as improvement of the applicability of the coal ashes to various applications and effective usage of by-product carbonate.

In order to solve the above-mentioned problems, the inventors have eagerly studied a method which allows co-existence of a process of performing separation and fixation of CO₂ at the same time and a process of not using an expensive absorbing solution and/or an adsorbent. As a result, the inventors have found that a method of fixating CO₂ using Ca included coal ashes generated by a coal thermal power plant allows separation and fixation of CO₂ at the same time and reformation of those coal ashes into one that is suitable for a cement admixture or a clay alternative material, and then the present invention has been completed.

In other words, the present invention provides a carbon dioxide absorption and fixation method, which fixates the carbon dioxide as carbonate by gas-liquid contacting flue gas with coal ash water slurry or coal ash eluate so as to react with the carbon dioxide in the flue gas and be absorbed thereinto.

The present invention also provides a carbon dioxide absorption and fixation method, wherein the coal ash eluate in the aforementioned method is obtained by preparing the coal ash water slurry and subjecting the slurry to solid-liquid separation. Note that it is preferable that the coal ash eluate is obtained by preparing the coal ash water slurry and subjecting the slurry to solid-liquid separation in this carbon dioxide absorption and fixation method. In addition, the coal ash water slurry can be mixed water slurry of coal ash and another CaO included compound in the carbon dioxide absorption and fixation method.

Furthermore, the present invention provides the carbon dioxide absorption and fixation method, wherein the flue gas is flue gas from a boiler at a coal thermal power plant. In other words, according to this method, using the Ca included coal ashes or the like for CO₂ fixation allows separation and fixation of CO₂ within flue gas at the same time, and effective usage of those coal ashes. More specifically, using this method in a coal thermal power plant allows usage and reformation of coal ashes at the same time, control of release of carbon dioxide to the atmosphere, and effective usage of by-products (calcium carbonate.) Note that it is preferable that the coal ash includes 10 wt % or greater of CaO in the composition thereof in the carbon dioxide absorption and fixation method. Usage of coal ash including 10 wt % or greater of CaO allows a higher Ca ion concentration in the carbon dioxide absorbing solution, thereby increasing the fixation efficiency.

Furthermore, the present invention provides reformed coal ash, which is coal ash that has been used for the carbon dioxide absorption and fixation method, and which is separated and collected from the coal ash water slurry, which is used to gas-liquid contact the flue gas and make the carbon dioxide in the flue gas react and be absorbed thereinto. According to the present invention, coal ash including less eluted alkali components can be obtained, therefore, it can be favorably used as a cement admixture or a clay alternative material.

Moreover, the present invention provides a calcium carbonate manufacturing method, which uses the carbon dioxide absorption and fixation method to gas-liquid contact flue gas (preferably, coal-fired flue gas) to an eluate, which is obtained by subjecting coal ash water slurry to solid-liquid separation, making the carbon dioxide in the flue gas react and be absorbed thereinto and collecting a deposit product. According to this method, highly pure and particulate calcium carbonate can be obtained.

In addition, the present invention provides a desulfurizing agent, which includes the calcium carbonate manufactured by this method.

### BRIEF DESCRIPTION OF THE DRAWINGS

FIG. 1 is a process flow diagram showing a first embodiment of the present invention;

FIG. 2 is a schematic diagram showing carbon dioxide fixation according to the present invention;

FIG. 3 is an electron micrograph of a deposit obtained in a first working example; and

FIG. 4 is an electron micrograph of a deposit obtained in a second working example.

### DETAILED DESCRIPTION OF THE PREFERRED EMBODIMENT

A carbon dioxide (CO₂) absorption and fixation method according to the present invention is a method of fixating the carbon dioxide as carbonate by contacting flue gas with coal ash water slurry or eluate thereof so as to make the carbon dioxide within the flue gas react and be absorbed thereinto.

The carbon dioxide absorption and fixation method according to the present invention is applicable to fixation of carbon dioxide included in flue gas that includes that carbon dioxide. In this case, the carbon dioxide included flue gas includes, for example, flue gas, which is emitted from a thermal power plant that runs using coal, oil, liquefied natural gas (LNG), LNG combined-cycles or the like; by-product gas generated by a steel plant, such as hot-air oven flue gas, blast furnace flue gas, converter flue gas, or flue gas; and flue gas, such as that generated when combusting scrap plastic, municipal waste, ligneous system biomass or the like. Carbon dioxide included in such flue gases occupies 1 to 50% by volume relative to the entire flue gases, and those gases include oxygen, nitrogen, and the like, as well as the carbon dioxide. Since the by-product coal ash obtained in a combustion process can be particularly used effectively, it is preferable that the coal ash is used to remove CO₂ from flue gas generated by a coal thermal power plant.

Coal ash generally includes various sorts of metallic oxides. Although the type and amount of included metallic oxides varies depending on the type of coal, metallic oxides such as SiO₂, Al₂O₃, and Fe₂O₃, alkali metallic oxides such as Na₂ and K₂O, and alkali-earth metallic oxides such as CaO and MgO are normally included. Accordingly, by contacting carbon dioxide included in flue gas with an eluate including a component eluted to water from coal ash so as to make a reaction of CaO+CO₂→CaCO₃, carbonate is generated and the carbon dioxide is fixated.

When absorbing CO₂ by contacting carbon dioxide included flue gas with a coal ash eluate, the flue gas should be blown into coal ash water slurry, or coal ash eluate. Usage of coal ash water slurry made by dispersing coal ash throughout water as CO₂ absorbing solution and directly blowing flue gas thereto allows fixation of CO₂ directly to the coal ash as well as fixation as the aforementioned carbonate.

Considering collection of injected coal ashes, separation from generated carbonate, and reuse thereof, it is preferable to make flue gas contact with an eluate, which is made from a solution (for example, filtrate) obtained by preparing highly concentrated coal ash water slurry, dissolving the eluted component of the coal ash into water, and then subjecting the solid component such as coal ash to solid-liquid separation. According to this method, the coal ash can be reformed so as to have properties suitable as a cement admixture or a clay alternative material, and collected carbonate can be used as a sulfur oxide desulfurizing agent within flue gas generated by a coal burning boiler.

Although the concentration of the above-mentioned coal ash water slurry is not limited since the type and amount of metallic oxides included in the coal ash water slurry varies depending on the type of coal, it is preferable that 4 to 40 wt %, more preferably 5 to 20 wt % of coal ash relative to 100 wt % of water should be mixed considering the carbon dioxide fixation efficiency. As a guideline, it is preferable that the slurry is prepared so that the CaO concentration in the slurry is 1 to 10 wt % relative to the entire slurry. As the slurry concentration is too low, the concentration of eluted calcium ions becomes lower, resulting in decrease in carbon dioxide fixation efficiency, while as the slurry concentration is too high, the slurry viscosity increases, resulting in decrease in handleability. Note that when dissolving a CaO component included in coal ash into water, dissolving conditions such as dissolving time period and dissolving temperature should be suitably specified, and a means such as stirring should be implemented if necessary.

When absorbing and fixating CO₂ by introducing flue gas into the above-mentioned coal ash water slurry or eluate, the higher the temperature exceeds room temperature, the less the solubility of carbon dioxide (CO₂ gas) to water. Therefore, it is preferable that liquid temperature is 10 to 30° C., but not limited thereto.

If alkali metallic oxides or alkali-earth metallic oxides, more specifically, CaO is included, the coal ash used in the present invention is not limited, but the coal ash with high CaO content is favorable. It is preferable that the CaO content is 10 wt % or greater (a ratio relative to the entire amount of coal ash), more preferably, it is 20 wt % or greater. Usage of coal ash with high CaO content makes it unnecessary to inject a large quantity of coal ashes in order to increase the calcium ion concentration in water, resulting in the superior handleability of slurry and increase in the carbon dioxide fixation efficiency.

The coal ash generated when combusting coal includes fly ash (EP ash), which is collected by an electrostatic precipitator, and bottom ash. Fly ash is favorable as coal ash. This is because the fly ash has less unburned carbon deposits but a lot of globular particles, and highly concentrated water slurry can be prepared easily. In addition, since carbon dioxide can be fixated directly on the surface thereof, the fly ash has superior carbon dioxide fixation ability. In general, fly ash having an average particle size of 5 to 30 μm is used. The fly ash may include a small amount (approximately 5 wt % or less) of unburned carbon deposits.

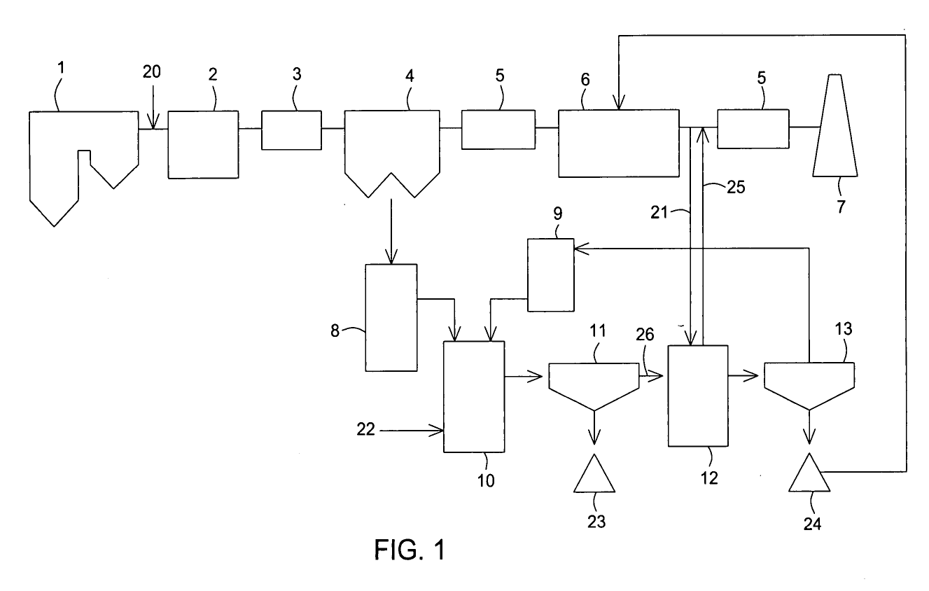

FIG. 1 shows a process flow at a coal thermal power plant as an exemplary embodiment of the present invention. When combusting coal in a boiler 1, coal ash (fly ash) within flue gas passes through an NOx removal unit 2 and an A/H (air preheater) 3, and is then collected by an electrostatic precipitator 4 arranged on the downstream side. The collected coal ash is once stored in a coal ash tank 8. On the other hand, since sulfur oxide (SOx) is formed by combusting sulfur included in coal in the boiler, flue gas cannot be released into the atmosphere from a chimney 7. Therefore, a wet-type desulfurizing unit 6 is normally deployed.

The coal ash stored in the coal ash tank 8 is mixed with water, which is supplied from a water tank 9, in a coal ash-water mixing tank 10 so as to make an approximately 5 to 20 wt % slurry. The mixing tank 10 operates such as stirring so as to dissolve Ca within the coal ash into water. Flue gas 21 may be directly blown into the coal water slurry. Referencing an exemplary drawing (FIG. 1), coal water slurry including dissolved Ca is separated by a solid-liquid separator 11 into eluate 26 and coal ash 23. Thereafter, flue gas 21 is branched on the downstream side of the wet-type desulfurizing unit 6 and blown into the eluate 26, which is poured into a carbon dioxide gas fixation tank 12, so as for the eluate to absorb carbon dioxide within flue gas, resulting in fixating CO₂ as CaCO₃.

In the above-mentioned coal ash-water mixing tank 10, coal ash or coal slag alone or mixture thereof can be injected; alternatively, a CaO included compound 22 may be injected, preparing mixed slurry. For example, at a power plant, seawater is pumped up and used as cooling water for each facility; however, shells are attached to an intake or the like for cooling water. Therefore, it is necessary to remove the shells from the intake or the like regularly. The collected shells are subjected to incineration by a shell incinerator and lime in the shells is collected. This collected lime can be used for carbon dioxide fixation by injecting it into the coal ash-water mixing tank 10.

In addition, various substances capable of preparing Ca eluate other than the above-mentioned lime may be used as the above-mentioned CaO included compound. In particular, a substance which can be obtained in large quantity at low cost is favorable. Generally, since combustion ash includes various metallic oxides such as CaO, incinerated ash such as municipal waste, industrial waste or the like, and scrap concrete can be used.

Note that when preparing mixed water slurry that includes coal ash and lime or refuse incinerated ash obtained through shell incineration, the mixture ratio thereof is not limited, but it is preferable that that slurry is prepared so that the CaO concentration in the slurry is 1 to 10 wt % relative to the entire slurry.

According to the present invention, a theoretical quantity or greater of flue gas 21 is normally supplied to the carbon dioxide gas fixation tank 12, and unreacted flue gases 25, which have not been fixated, are recycled. Carbonate fixated in the above-mentioned manner is separated by the solid-liquid separator 13 and calcium carbonate (CaCO₃) 24 is then collected.

The calcium carbonate 24, which has been separated and collected, can be used as an absorbent in the wet-type desulfurizing unit 6. For example, dihydrate gypsum can be obtained by absorbing the sulfur oxide included in the flue gas into the calcium carbonate slurry, which has been separated and collected, so as to form calcium sulfite, and then oxidizing it. The calcium carbonate can be used as a desulfurizing agent in the wet-type desulfurizing unit 6, and can also be used as a building material or a coating composition.

On the other hand, coal ash separated from the eluate by the solid-liquid separator 11 is collected as reformed coal ash 23 that eluted components are removed. The reformed coal ash can be used as a cement admixture or a clay alternative material.

Effects of the invention

As described above, according to the present invention, a large amount of generated coal ashes can be used effectively, and carbon dioxide included in flue gases of coal, refuse, or waste products can be fixated efficiently. Furthermore, the spent coal ash has superior applicability to the cement admixture or the clay alternative material, and the by-product carbonate can be reused as a desulfurizing agent. In addition, since a Ca source used in the present invention utilizes the Ca in ashes which are originally included in coal itself, additional feedstock is unnecessary. According to a method of the present invention, components to be eluted into water from the used coal ash can be removed. As a result, applicability of coal ash to the cement admixture or the clay alternative materials increases, and there is an effect that hazardous components to be eluted from the coal ash can be suppressed. Therefore, collection of CO₂ at a coal thermal power plant becomes possible at low cost.

Working Examples

Working examples are given forthwith in order to describe the present invention more specifically, but the present invention is not limited to the following working examples. In each of the following working examples, ‘wt %’ is abbreviated as ‘%’ unless otherwise specified.

### EXAMPLE 1

A Ca dissolution experiment is implemented by adding 100 g of coal A ash shown in Table 1 to 1000 ml of water so as to form 10% slurry and then stirring it for five minutes in a beaker. The prepared slurry is filtrated by a membrane filter of 1 micron, providing filtrate and a residue of coal ash. The Ca ion concentration in the solution is measured to be 1216 ppm.

Since the CaO content in coal A is 18.19%, 100 g of coal ash includes 18.19 g of CaO. The amount of dissolved CaO is found as 1.70 g from the Ca ion concentration in the solution, which has been subjected to the dissolution experiment, which means that 9.3% of included CaO is dissolved.

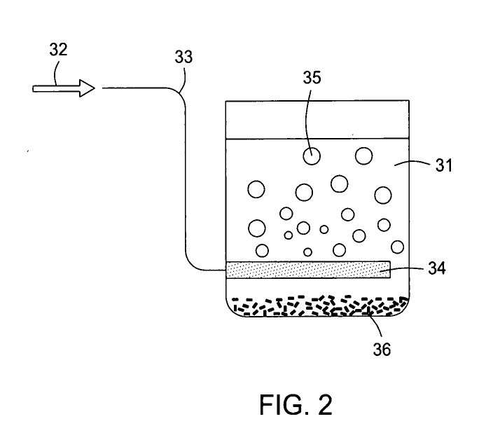

Next, a CO₂ absorption experiment is implemented by preparing 800 ml of that filtrate and then blowing gas including 15% and 85% by volume of CO₂ and N₂, respectively, into that prepared filtrate at a flow rate of 1000 ml/min using a glass tube with a bubble generator for twenty minutes. FIG. 2 shows the process of the experiment. In the drawing, 31 represents coal ash eluate, 32 represents flue gas, 33 represents piping, 34 represents a bubble generator, 35 represents air bubbles, and 36 represents deposits. As a result, deposits of microscopic white crystals that can be thought as calcium carbonate are identified.

The slurry after being subjected to the absorption experiment is filtrated by the membrane filter, separating it into filtrate and a white solid. The Ca ion concentration in the filtrate is measured to be 394 ppm.

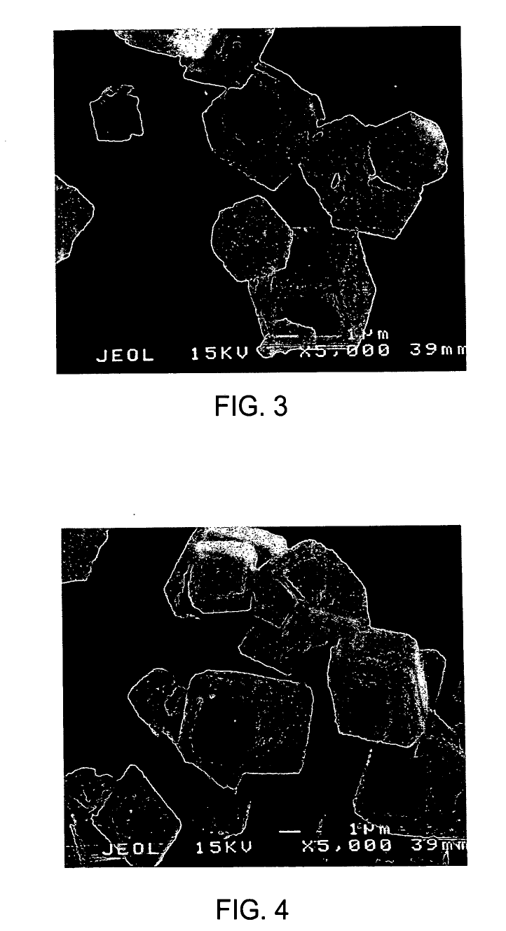

On the other hand, the separated white solid is dried and the weight thereof is then measured to be 1.59 g. Through analysis using the X-ray diffraction instrument, this white solid is determined as CaCO₃. In addition, as a result of observation using an electron microscope (×5000), the solid is identified as a microscopic crystal of 5 micron or less as shown in a micrograph (FIG. 3).

### EXAMPLE 2

A Ca dissolution experiment is implemented by adding 100 g of coal B ash shown in Table 1 to 1000 ml of water so as to form 10% slurry and stirring it for five minutes in a beaker. The prepared slurry is filtrated by a membrane filter of 1 micron, providing filtrate and a residue of coal ash. The Ca ion concentration in the solution is measured to be 986 ppm.

Since the Cad content in coal B is 8.35%, 100 g of coal ash includes 8.35 g of CaO. The amount of dissolved CaO is found as 1.38g from the Ca ion concentration in the solution, which has been subjected to the dissolution experiment, which means that 16.5% of included CaO is dissolved.

Next, a CO₂ absorption experiment is implemented by preparing 800 ml of that filtrate and then blowing gas including 15% and 85% by volume of CO₂ and N₂, respectively, into that prepared filtrate at a flow rate of 1000 ml/min using a glass tube with a bubble generator for twenty minutes in the same manner as the first working example. As a result, deposits of microscopic white crystals that can be thought as calcium carbonate are identified.

The slurry after being subjected to the absorption experiment is filtrated by the membrane filter, separating it into filtrate and a white solid. The Ca ion concentration in the filtrate is measured to be 383 ppm, which is almost equivalent to that of coal A.

On the other hand, the separated white solid is dried and the weight thereof is then measured to be 1.11 g. Through analysis using the X-ray diffraction instrument, this white solid is determined as CaCO₃. In addition, as a result of observation using an electron microscope (×5000), the solid is identified as a microscopic crystal of 5 micron or less as shown in a micrograph (FIG. 4).

TABLE 1
Composition of coal ash (wt %)

| Component | Coal A | Coal B |
|---|---|---|
| SiO₂ | 53.28 | 63.91 |
| Al₂O₃ | 13.37 | 11.66 |
| TiO₂ | 0.74 | 0.73 |
| Fe₂O₃ | 4.47 | 7.01 |
| CaO | 18.19 | 8.35 |
| MgO | 5.79 | 1.27 |
| Na₂O | 0.00 | 0.33 |
| K₂O | 0.75 | 0.07 |
| P₂O₅ | 0.16 | 0.37 |
| SO₃ | 0.00 | 0.00 |
| Residue | 3.25 | 6.30 |

1. A carbon dioxide absorption and fixation method, which fixates the carbon dioxide as carbonate by gas-liquid contacting flue gas with coal ash water slurry or coal ash eluate so as to react with the carbon dioxide in the flue gas and be absorbed thereinto.

2. The carbon dioxide absorption and fixation method according to claim 1, wherein the coal ash eluate is obtained by preparing the coal ash water slurry and subjecting the slurry to solid-liquid separation.

3. The carbon dioxide absorption and fixation method according to claim 1, wherein the gas-liquid contact between the flue gas and the coal ash water slurry or the coal ash eluate and reaction and absorption thereafter are implemented at a liquid temperature of 10 to 30° C.

4. The carbon dioxide absorption and fixation method according to either claim 1, wherein the coal ash includes 10 wt % or greater of CaO in the composition thereof.

5. The carbon dioxide absorption and fixation method according to claim 1, wherein the coal ash is fly ash.

6. The carbon dioxide absorption and fixation method according to claim 1, wherein the flue gas is at least one type of gas selected from a group consisting of flue gases emitted from a thermal power plant, hot-air oven flue gas, blast furnace flue gas, converter flue gas, flue gases, flue gases of scrap plastic, flue gases of municipal waste, and flue gases of ligneous system biomass.

7. The carbon dioxide absorption and fixation method according to claim 1, wherein the flue gas is flue gas from a boiler at a coal thermal power plant.

8. The carbon dioxide absorption and fixation method according to claim 1, wherein the coal ash water slurry is mixed water slurry of coal ash and another CaO included compound.

9. The carbon dioxide absorption and fixation method according to claim 1, wherein the coal ash water slurry includes 5 to 40 wt % of coal ash relative to 100 wt % of water.

10. Reformed coal ash, which is coal ash that has been used for the carbon dioxide absorption and fixation method according to claim 1, and which is separated and collected from the coal ash water slurry, which is used to gas-liquid contact the flue gas and make the carbon dioxide in the flue gas react and be absorbed thereinto.

11. A calcium carbonate manufacturing method, which uses the carbon dioxide absorption and fixation method according to claim 1 to gas-liquid contact flue gas to an eluate, which is obtained by subjecting coal ash water slurry to solid-liquid separation, making the carbon dioxide in the flue gas react and be absorbed thereinto and collecting a deposit product.

12. A desulfurizing agent, which includes the calcium carbonate manufactured by the method according to claim 11.
